(19) United States
(12) Patent Application Publication
(10) Pub. No.: US 2015/0046136 A1
(43) Pub. Date: Feb. 12, 2015

(54) METHOD FOR GENERATING RIP CURRENT WARNING

(71) Applicants: KOREA INSTITUTE OF CONSTRUCTION TECHNOLOGY, Goyang-si, Gyeonggi-do (KR); REPUBLIC OF KOREA (KOREA HYDROGRAPHIC AND OCEANGRAPHIC ADMINISTRATION DIRECTOR MINISTRY OF +, Yeongdo-gu, Busan (KR)

(72) Inventors: Jun Woo Choi, Seoul (KR); Chae Ho Lim, Anyang-si (KR)

(21) Appl. No.: 14/387,827

(22) PCT Filed: Mar. 25, 2013
(86) PCT No.: PCT/KR2013/002446

§ 371 Date: Sep. 24, 2014

(30) Foreign Application Priority Data
Mar. 27, 2012 (KR) 10-2012-0030868

(51) Int. Cl. G08B 21/10

(52) U.S. Cl. CPC G08B 21/10
USPC 703/2

(57) ABSTRACT

A method for generating a rip current warning generates a rip current warning for a target region in real time by comprising the steps of: (S1) calculating a speed of ocean current; (S2) calculating a rip current generation index; (S3) creating a database by changing the virtual marine condition scenario and calculating the rip current generation index; and (S4) determining whether the rip current warning is generated through a correlation between the presently measured marine condition and the rip current index information on each marine condition previously calculated with the creation of a database by understanding the real-time-measured marine condition in the target region.

### TECHNICAL FIELD

The present disclosure relates to a method for generating a rip current alarm, which quantitatively calculates likelihood of rip currents in the coast and informs a rip currents occurrence risk according to preset alarm classification.

### BACKGROUND ART

In domestic and foreign beaches, people swimming at the beach have been frequently swept away to the deep sea due to rip currents. The rip current causing such an accident is a “sudden” rip current which abruptly happens and lasts about 5 minutes or less. Therefore, when a wave invades to the near shore from the open sea, a flow velocity of a sea current occurring from the near shore toward the open sea should be analyzed to determine whether a rip current occurs, and then if necessary, a rip current alarm such as evacuation from the near shore should be generated.

However, in the existing technique, a rip current occurrence alarm is generated several times per day, just based on weather forecast. In the existing technique, a system for predicting a rip current in consideration of actual situations and generating a rip current alarm based on such prediction has not been constructed at all, and a technique for performing the same has not been proposed at all.

Korean Unexamined Patent Publication No. 10-2008-52718 (with a Korean Patent Application No. 2006-124235) discloses a method for simulating an ocean discharge system, but by using this technique, it is impossible to derive a method for predicting a rip current or generating a rip current alarm.

### DISCLOSURE

### Technical Problem

The present disclosure is designed to minimize an accident caused by a rip current, and the present disclosure is directed to providing a method for determining based on real-time observation information whether a rip current is generated, and for generating an alarm in real time based on the determination result.

### Technical Solution

In one general aspect, the present disclosure provides a method for generating a rip current alarm, which includes: calculating a sea current flow velocity from the simulation of a state in which a rip current occurs at a target region, which is to be monitored in regard to occurrence of a rip current, based on geographic information of the target region and a virtual sea condition scenario; calculating a rip current occurrence index by quantifying the degree of rip current occurrence at the target region as an index varied in accordance with the virtual sea condition scenario based on the calculated sea current flow velocity information; calculating the rip current occurrence index varied in accordance with the various virtual sea condition scenario, and building a database of the rip current occurrence index; and determining whether or not to generate a rip current occurrence alarm based on a correlation between the sea condition measured in real time at the target region and the rip current index information of each sea condition stored in the database, whereby a rip current alarm about the target region is generated in real time.

In the present disclosure, the rip current occurrence index calculating step may include: extracting a maximum rip current flow velocity at the target region for each measurement time from the rip current flow velocity calculated under the various virtual sea condition scenario; calculating an accumulated dangerous rip current occurrence time by accumulating time in which the maximum rip current flow velocity at each measurement time is larger than a preset limit flow velocity where a rip current becomes dangerous; calculating a ratio of the accumulated dangerous rip current occurrence time to a simulation time; and quantifying the degree of rip current occurrence as a numerical index by designating the ratio of the calculated accumulated dangerous rip current occurrence time as a preset rip occurrence index.

In addition, in the present disclosure, in the step of calculating the rip current occurrence index varied according to the various virtual sea condition scenario and building a database of the rip current occurrence index, a correlation mathematically representing a relation between the virtual sea condition scenario and the quantified rip current occurrence index is derived.

Further, the step of determining whether or not to generate a rip current occurrence alarm may include: obtaining information of an actual sea condition (i.e., heighth, period, direction, spectrum) of a wave and a tide at a corresponding sea location, where the virtual sea condition scenario has been set, with respect to the target region; extracting a virtual sea condition scenario which matches with the current actual sea condition by comparing the information of the actual sea condition of a wave and a tide with virtual sea condition scenarios which have been used for simulation in advance; and determining whether or not to generate a rip current alarm and determining the kind of the rip current alarm, according to a quantified rip current occurrence index calculated in advance and a rip current alarm generation criteria classified for each rip current occurrence index, with respect to the extracted virtual sea condition scenario, and generating a rip current alarm accordingly.

As an alternative, the step of determining whether or not to generate a rip current occurrence alarm may also include: obtaining information of the actual sea condition of a wave and a tide at a corresponding sea location where the virtual sea condition scenario has been set, with respect to the target region; calculating a rip current occurrence index by applying the actual sea condition of a wave and a tide at the target region to a correlation mathematical function between the rip current occurrence index and a virtual sea condition scenario derived in advance; and determining whether or not to generate a rip current alarm and determining the kind of the rip current alarm, according to a quantified rip current occurrence index calculated in advance and a rip current alarm generation criteria classified for each rip current occurrence index, and generating a rip current alarm accordingly.

### Advantageous Effects

According to the present disclosure, it is possible to estimate whether a rip current occurs based on information observed at a target region of a coast in real time, and therefore, it is possible to generate a rip current occurrence alarm in real time. Therefore, according to the present disclosure, it is possible to greatly reduce accidents caused by rip currents at coasts.

In particular, according to the present disclosure, a rip current occurrence alarm, which accords with actual situations may be generated within a very short time, and thus a suitable alarm accurately reflecting actual situations, which changes in real time, may be generated.

### DESCRIPTION OF DRAWINGS

FIG. 1 is a flowchart for schematically illustrating a method for generating a rip current alarm according to the present disclosure.

FIG. 2 is a flowchart for illustrating a step of deriving sea current flow velocity information from simulating occurrence of a rip current at a target region by using a virtual sea condition scenario in the method for generating a rip current alarm according to the present disclosure.

FIG. 3 is a flowchart for illustrating a step of quantifying the degree of rip current occurrence as a numerical index.

FIG. 4 shows an example of the graph in which the horizontal axis represents a simulation time and the vertical axis represents an extracted maximum rip current flow velocity.

FIG. 5 is a flowchart for illustrating a step of determining whether or not to generate a rip current occurrence alarm.

### BEST MODE

Hereinafter, the embodiments of the present disclosure will be described in detail with reference to the accompanying drawings. Even though the present disclosure is described with reference to the embodiments depicted in the drawings, they are just examples, and the technical spirit, essence and operations of the present disclosure are not limited thereto.

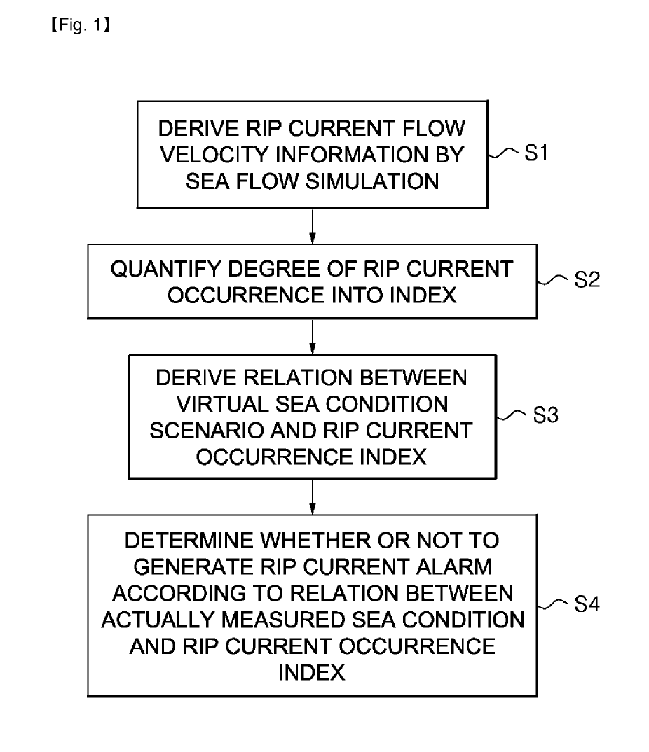

FIG. 1 is a flowchart for schematically illustrating a method for generating a rip current alarm according to the present disclosure. As shown in FIG. 1, the method for generating a rip current alarm according to the present disclosure includes (Step S1) obtaining sea current flow velocity information by the simulation of a state in which a rip current occurs at a region which is to be monitored in regard to occurrence of a rip current (hereinafter, referred to as a “target region”), based on geographic information of the target region and a virtual sea condition scenario; (Step S2) calculating a rip current occurrence index by quantifying the degree of rip current occurrence at the target region as an index varied according to the virtual sea condition scenario, based on sea current flow velocity information calculated from the result of the above simulation; (Step S3) building a database of relationship between the quantified rip current occurrence indices and the virtual sea condition scenarios; and (Step S4) determining whether or not to generate a rip current occurrence alarm by using a correlation between the rip current index information of each sea condition stored in the database and the sea condition (a wave height, a wave period, a wave direction, a wave spectrum and a tide level) measured in real time at the target region.

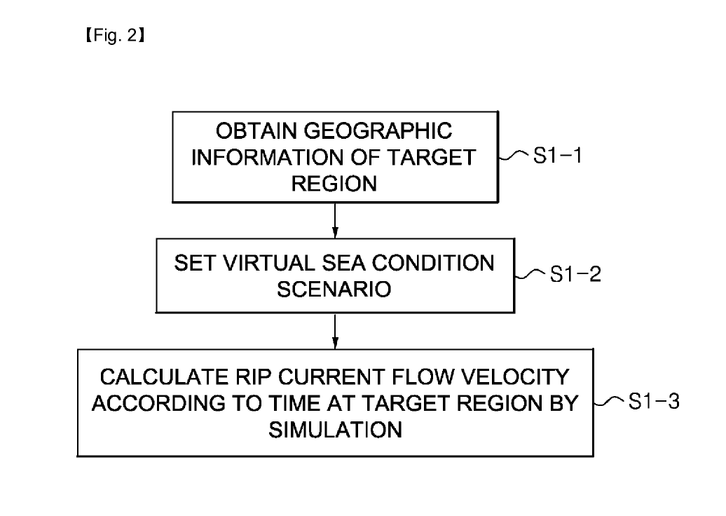

FIG. 2 is a flowchart for illustrating the first step performed in the method of the present disclosure, namely Step S1 of calculating sea current flow velocity information based on the simulation of a state in which a rip current occurs at a target region. Such simulation may be conducted based on geographic information of the target region and a virtual sea condition scenario. Hereinafter, Step S1 will be described in detail with reference to FIG. 2.

First, geographic information of a region, which is to be monitored in regard to occurrence of a rip current (a target region), is obtained (Step S1-1). Here, the geographic information means water depth information(i.e., bathymetry) of the target region. In order to perform the method of the present disclosure, first of all, the water depth information of the entire target region should be figured out. For example, water depth information of the entire target region is figured out by means of precise measurements to make a contour map in which water depths of the target region are expressed with contours. In the present disclosure, water depth information of the target region is obtained as geographic information by using a given contour map or newly performing measurements.

After the geographic information of the target region is obtained, or along with it, a virtual sea condition scenario which may cause a rip current at the target region is set (Step S1-2). In other words, a wave height, a wave period, a wave direction, a wave spectrum and a tide level, which may occur at an offshore point far from the coast, are set at random. For convenience, in this specification, a wave height, a wave period, a wave direction, a wave spectrum and a tide level will be briefly called “sea conditions”. However, the sea conditions are not limited to above, and another physical characteristics of waves in relation to occurrence of rip currents may be further included in the sea conditions. In this specification, the sea conditions include a wave height, a wave period, a wave direction, a wave spectrum and a tide level described above.

By using a known sea current prediction simulation program, in which the obtained geographic information of the target region and the preset virtual sea conditions (namely, the virtual sea condition scenario) are used as input values, a sea current flow velocity formed from the near shore to the open sea (a rip current flow velocity) is calculated for the preset virtual sea condition scenario. In detail, the state when the virtual sea condition scenario occurs is simulated by changing the preset virtual sea condition scenarios in order to calculate a rip current flow velocity at the target region according to time (Step S1-3).

A sea current prediction simulation program (“a sea current simulator”) for mathematically calculating a sea current flow velocity(speed and direction of a flowing sea water) occurring at a specific point of the coast, toward which a wave of a given sea condition generated at an open sea far from the coast surges, is already known in the art. In other words, if a mathematical simulation is performed using a known sea current simulator, the flow velocity of a sea current generated at a known water depth toward the open sea due to the surging wave may be figured out in the case that a wave of a specific sea condition generated at an open sea far from the coast propagates to the coast. Here, the sea current flow velocity obtained by the sea current simulator is a vector quantity having information about not only a flowing magnitude of the sea current but also a flowing direction of the sea current. In addition, the sea current simulator capable of performing such a simulation is already known in the art as described above, and thus its detailed configuration and simulating method will not be described in detail here.

In the present disclosure, the “flow velocity toward the open sea according to time”, which occurs the entire target region, is calculated by changing each sea condition of a variety of the virtual sea condition scenarios, which occurs at an open sea located far from the coast of the target region, by using the known “sea current simulator”. In other words, as described above, sea conditions such as a wave height, a wave period, a wave direction, a wave spectrum and a tide level, which occur at an open sea point far from the coast of the target region, are set as input conditions of the simulation. Further, a mathematical simulation is performed by using a known sea current simulator, thereby calculating a successive sea current flow velocity (a vector quantity having a sea current direction and a sea current flow magnitude), namely a rip current flow velocity, which develops toward the open sea during a predetermined period (a simulating time) at a desired location due to a wave of a corresponding virtual sea condition scenario. For example, after setting a virtual sea condition scenario, in which regular waves with a wave height of 1.0 m, and a wave period of 10 seconds, and a wave direction from the south propagate toward the target region from a specific open sea point, a sea current flow velocity (namely, a rip current flow velocity) generated toward the open sea with respect to the entire target region is mathematically obtained by the known sea current simulator.

Further, while variously changing the sea conditions at the open sea, a rip current flow velocity toward the open sea with respect to the entire target region according to time at each virtual sea condition scenario is calculated in advance. In the present disclosure, as described above, by setting and simulating various virtual sea condition scenarios which may occur at a specific open sea point with respect to a target region whose geography and depth are already known, the “rip current flow velocity according to time” occurring at the target region may be calculated in advance.

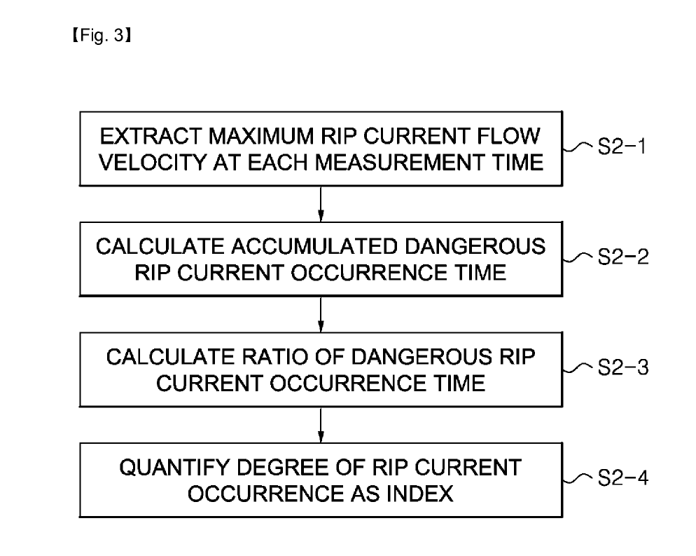

In the present disclosure, after calculating the rip current flow velocity according to time occurring at the target region by the simulation of various virtual sea condition scenarios as described above, based on the sea current flow velocity derived from the simulation result, the degree of rip current occurrence generated at the target region is quantified as an index according to the virtual sea condition scenario (Step S2). FIG. 3 is a flowchart for illustrating a step of quantifying the degree of rip current occurrence as an index.

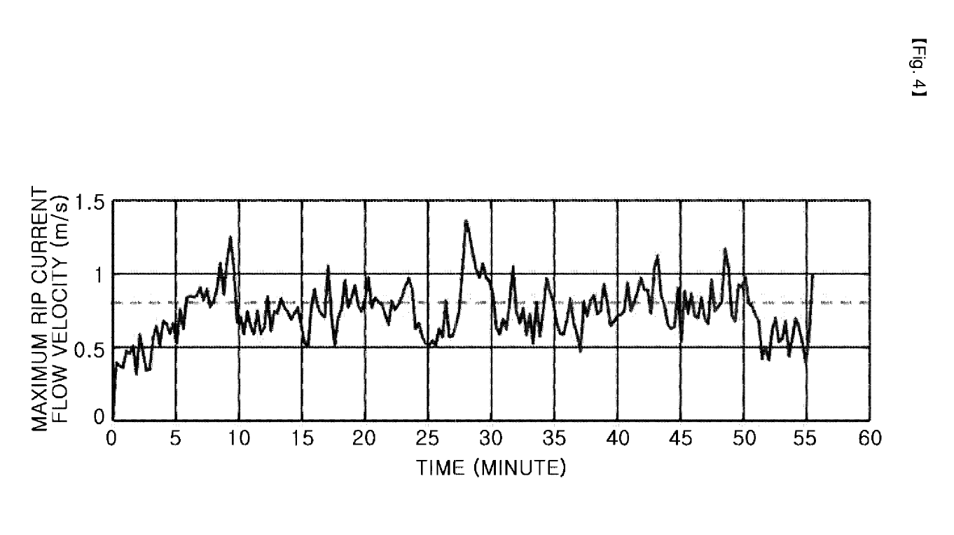

In order to quantify the degree of rip current occurrence as an index, a maximum rip current flow velocity at each measurement time is extracted from the <rip current flow velocity occurring at the target region according to time> based on the simulation of various virtual sea condition scenarios as described above (Step S2-1). By setting the virtual sea condition scenario so that regular waves with a wave height of 1.0 m, a wave period of 10 seconds, and wave direction from the south surges toward the target region, and then using the sea current simulator, a rip current flow velocity in the entire target region may be calculated. In addition, among the calculated rip current flow velocities, the greatest rip current flow velocity in the target region at each measurement time is extracted as a “maximum rip current flow velocity at each measurement time”. In other words, if various virtual sea condition scenarios are simulated by using the sea current simulator, a graph, in which a horizontal axis represents a simulation time and a vertical axis represents a rip current flow velocity of each point of the target region, may be obtained. In this graph, the greatest value of the vertical axis values with respect to each measurement point of the target region at a specific time in the horizontal axis is calculated and selected as a maximum flow velocity at the corresponding measurement time. This work is performed to the entire simulation period to obtain a graph in which the horizontal axis represents the simulation time and the vertical axis represents the maximum values of the extracted rip current flow velocity (the maximum rip current flow velocity). FIG. 4 shows an example of a graph in which the horizontal axis represents a simulation time and the vertical axis represents an extracted maximum rip current flow velocity.

The case, in which “the maximum rip current flow velocity at each measurement time” extracted from the rip current flow velocity calculated by the simulation result is larger than a preset limit flow velocity, is defined as a “state where a dangerous rip current may occur”. After the maximum rip current flow velocity at each measurement time is calculated, it is determined whether there is the “state where a dangerous rip current may occur” by comparing the calculated result (the maximum rip current flow velocity at each measurement time) with a preset limit flow velocity. Further, the time corresponding to the state, where a dangerous rip current may occur, is accumulated to calculate an “accumulated dangerous rip current occurrence time” (Step S2-2). For example, in the graph of FIG. 4, a dotted line represents the limit flow velocity, and the accumulated dangerous rip current occurrence time is calculated by summing up all of the horizontal axis time intervals when the maximum rip current flow velocity of each measurement time is larger than the limit flow velocity.

If the dangerous rip current occurrence time is calculated as described above, a ratio of the accumulated dangerous rip current occurrence time to the simulation time is obtained (Step S2-3). In other words, a percentage is obtained by putting the simulation time into a denominator and putting the accumulated dangerous rip current occurrence time into a numerator.

Meanwhile, an index representing the degree of rip current occurrence, namely a “rip current occurrence index”, is preset, and the rip current occurrence index may be set as a numeral. For example, the rip current occurrence index may be set as numerals from 0 to 1000. If the rip current occurrence index is 0, no rip current occurs, and if the rip current occurrence index is 1000, a rip current occurs to the maximum.

The numerals of the rip current occurrence index from 0 to 1000 are just examples, and the rip current occurrence index may also be set as 0 to 10, or other numerals may also be used. The setup of rip current occurrence index may be completed before conducting the simulations.

After the ratio of the accumulated dangerous rip current occurrence time to the simulation time, namely the “accumulated dangerous rip current occurrence time ratio”, is obtained, the preset “rip current occurrence index” is applied to the calculated accumulated dangerous rip current occurrence time ratio in order to quantify the degree of rip current occurrence by using the numerical index (Step S2-4). For example, if the rip current occurrence index is set as numerals from 0 to 100, the accumulated dangerous rip current occurrence time obtained as a percentage (%) may be set as the “rip current occurrence index” intactly. If the accumulated dangerous rip current occurrence time ratio is calculated as 30%, the <rip current occurrence index> may be regarded as 30. However, the quantifying work performed by applying the rip current occurrence index to the accumulated dangerous rip current occurrence time is not limited to the above example. The accumulated dangerous rip current occurrence time ratio may also be quantified into the rip current occurrence index by using the following procedure. When the rip current occurrence index is set as integers from 1 to 10, if the accumulated dangerous rip current occurrence time is calculated to be equal to or greater than 0% and smaller than 10%, “1” is endowed as the rip current occurrence index, and if the accumulated dangerous rip current occurrence time is calculated to be equal to or greater than 10% and equal to or smaller than 20%, “2” is endowed as the rip current occurrence index. The work for quantifying a rip current occurrence index is not limited to the above.

Meanwhile, separately from the “work for quantifying the degree of rip current occurrence at the target region by using an index according to the virtual sea condition scenario”, a work for determining a rip current alarm generation criteria in advance according to each rip current occurrence index is required. For example, if the rip current occurrence index is ranged from 0 to 10, a first-level rip current alarm is generated. If the rip current occurrence index is ranged from 10 to 20, a second-level rip current alarm is generated. If the rip current occurrence index is ranged from 20 to 30, a third-level rip current alarm is generated. In this way, a criterion for determining the kind of rip current alarm according to the rip current occurrence index is set in advance.

If Step S2 of quantifying the degree of rip current occurrence at the target region by using an index according to the virtual sea condition scenario is completed, a database regarding a relation between each virtual sea condition scenario and a resultant quantified rip current occurrence index is built (Step S3).

If Step S2 is completed, a quantified rip current occurrence index of the target region is calculated for each of various virtual sea condition scenarios. The calculated rip current occurrence index and the virtual sea condition scenario data used for producing the rip current occurrence index are stored to build a database.

If necessary, a correlation function representing a relation between a virtual sea condition scenario and a quantified rip current occurrence index is derived, and the derived correlation function is stored to build the database. For example, as sea conditions of a virtual sea condition scenario, a wave height is expressed as an alphabet “a”, a wave period is expressed as an alphabet “b”, and a wave direction is expressed as an alphabet “c”. Here, assuming that a rip current occurrence index calculated from the virtual sea condition scenario composed of the sea conditions “a”, “b” and “c” is “x”, a correlation function of f(a, b, c)=x may be derived from the calculated virtual sea condition scenario and the rip current occurrence index corresponding thereto. A correlation function representing a mathematical relation of data pairs of four elements can be derived by means of existing mathematical methods such as interpolation and curve fitting.

Instead of the work for building a database with data of the rip current occurrence index calculated with respect to the target region in each of various virtual sea condition scenarios, in the present disclosure, a mathematical correlation function between the virtual sea condition scenario and the rip current occurrence index is derived in advance by using the data.

In a state where Steps 51 to Step S3 are completely performed, it is determined whether or not to generate a rip current occurrence alarm by checking sea conditions measured in real time at the target region on the basis of the correlation between the currently detected sea conditions and the calculated rip current occurrence index of each virtual sea condition scenario (Step S4).

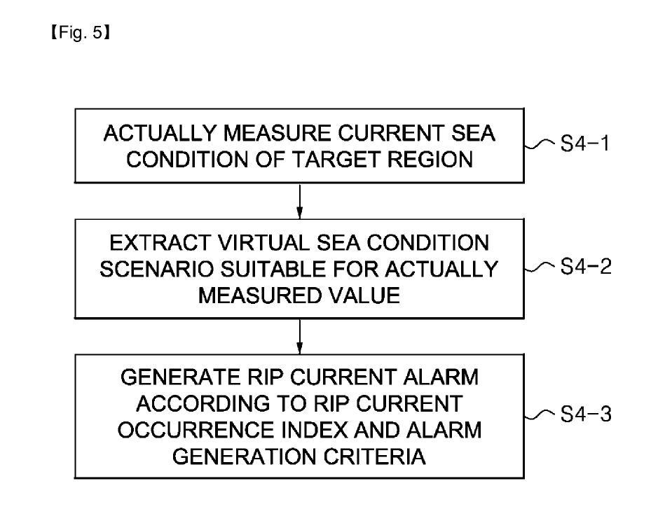

FIG. 5 is a flowchart for illustrating a step of determining whether or not to generate a rip current occurrence alarm (Step S4). As shown in FIG. 5, sea conditions of the virtual sea condition scenario (for example, a wave height, a wave period, a wave direction, a wave spectrum and a tide level), which actually occurs at an open sea location where the virtual sea condition scenario is set, are measured with respect to the target region in order to obtain information about the sea conditions (Step S4-1). After measuring sea conditions of the target region in real time and obtaining information about them, the obtained sea conditions of the actual wave are compared with the sea conditions of the virtual sea condition scenarios used in the simulation to extract a virtual sea condition scenario which has the virtual sea conditions identical to the current sea conditions (Step S4-2). If the virtual sea condition scenario identical to the current sea conditions is extracted through the above process, it is determined whether or not to generate a rip current alarm and which kinds of rip current alarm is to be generated according to the quantified rip current occurrence index of each virtual sea condition scenario calculated in advance through simulations and the rip current alarm generation criteria classified based on each rip current occurrence index, and then a rip current alarm is generated (Step S4-3).

Meanwhile, in the present disclosure, the calculated mathematical correlation function between the virtual sea condition scenario and the rip current occurrence index may be used to calculate a rip current occurrence index according to actually measured sea conditions of an open sea point, with respect to the target region (Step S4-5). In other words, a correlation function f (a, b, c)=x between the virtual sea condition scenario and the rip current occurrence index is calculated in advance based on the information from substantial simulations. Further, a wave height (expressed with a capital A), a wave period (expressed with a capital B) and a wave direction (expressed with a capital C) of the target region, which are actually measured, may be applied to the correlation function to calculate a value of f (A, B, C), namely an X value in f (A, B, C)=X (a numerical value of the degree of rip current occurrence with respect to actual sea conditions of the target region).

Through the above procedure, the rip current occurrence index for actually measured sea conditions of the target region is calculated, and the calculated rip current occurrence index is compared with the preset rip current alarm generation criteria classified in advance to determine whether or not to generate a rip current alarm and what kinds of rip current alarm is to be generated, and then a rip current alarm is generated accordingly.

As described above, in the present disclosure, waves possible to propagate to the target region are presumed to set various virtual sea condition scenarios, and a rip current flow velocity occurring at the target region, toward which a wave of each set virtual sea condition scenario propagates, is calculated in advance. A time interval, when the calculated rip current flow velocity has a maximum value larger than the limit flow velocity, is considered as a state where a dangerous rip current may occur. Further, in the state, in which the kind of rip current occurrence alarm is determined in advance according to a ratio of the duration of the dangerous rip current, the sea conditions of the wave occurring at the target region are measured in real time, and a corresponding rip current occurrence index is calculated. After that, a rip current occurrence alarm is generated according to the kind of rip current occurrence alarm corresponding thereto. Therefore, in the present disclosure, based on real-time observation of the target region, a rip current occurrence alarm suitable for an actual situation may be generated, and accordingly accidents at coasts may be greatly reduced.

In particular, in the present disclosure, since various virtual sea condition scenarios are simulated in advance and the resultant data are stored in a database so that the stored simulation data are compared with actually observed values, the rip current occurrence alarm suitable for an actual situation may be generated within a very short time, and thus a suitable alarm reflecting the actual situation, which changes in real time may be generated.

1. A method for generating a rip current alarm, comprising:
(Step S1) calculating a sea current flow velocity from the simulation of a state in which a rip current occurs at a target region, which is to be monitored in regard to occurrence of a rip current, based on geographic information of the target region and a virtual sea condition scenario;
(Step S2) calculating a rip current occurrence index by quantifying the degree of rip current occurrence at the target region by using an index according to the virtual sea condition scenario based on the calculated sea current flow velocity information;
(Step S3) calculating the rip current occurrence index varied according to the various virtual sea condition scenario, and building a database of the rip current occurrence index; and
(Step S4) determining whether or not to generate a rip current occurrence alarm by using a correlation between the sea condition measured in real time at the target region and the rip current index information of each sea condition stored in the database,
wherein the rip current occurrence index calculating step (Step S2) includes:
(Step S2-1) extracting a maximum rip current flow velocity at the target region for each measurement time from the sea current flow velocity calculated under the various virtual sea condition scenario;
(Step S2-2) calculating an accumulated dangerous rip current occurrence time by accumulating time in which the maximum rip current flow velocity at each measurement time is over a preset limit flow velocity where a rip current becomes dangerous;
(Step S2-3) calculating a ratio of the accumulated dangerous rip current occurrence time to the simulation time of a scenario; and
(Step S2-4) quantifying the degree of rip current occurrence as a numerical index by designating the ratio of the calculated accumulated dangerous rip current occurrence time as a preset rip current occurrence index,
whereby a rip current alarm about the target region is generated in real time.

2. The method for generating a rip current alarm according to claim 1,
wherein in the step (Step S3) of calculating the rip current occurrence index varied according to the virtual sea condition scenario and building a database of the rip current occurrence index, a correlation mathematically representing a relation between the virtual sea condition scenario and the quantified rip current occurrence index is derived.

3. The method for generating a rip current alarm according to claim 1,
wherein the step (Step S4) of determining whether or not to generate a rip current occurrence alarm includes:
(Step S4-1) obtaining information of an actual sea condition of a water surface at a corresponding sea location where the virtual sea condition scenario has been set, with respect to the target region;
(Step S4-2) extracting a virtual sea condition scenario which matches with the current actual sea condition by comparing the information of the actual sea condition of a water surface with virtual sea condition scenarios which have been used for simulation in advance; and
(Step S4-3) determining whether or not to generate a rip current alarm and determining the kind of the rip current alarm, according to a quantified rip current occurrence index calculated in advance and a rip current alarm generation criteria classified for each rip current occurrence index, with respect to the extracted virtual sea condition scenario, and generating a rip current alarm accordingly.

4. The method for generating a rip current alarm according to claim 1,
wherein the step (Step S4) of determining whether or not to generate a rip current occurrence alarm includes:
(Step S4-1) obtaining information of the actual sea condition of a water surface at a corresponding sea location where the virtual sea condition scenario has been set, with respect to the target region;
(Step S4-5) calculating a rip current occurrence index by applying the actual sea condition of a water surface at the target region to a correlation mathematical function between the rip current occurrence index and the virtual sea condition scenario derived in advance; and
determining whether or not to generate a rip current alarm and determining the kind of the rip current alarm, according to a quantified rip current occurrence index calculated in advance and a rip current alarm generation criteria classified for each rip current occurrence index, and generating a rip current alarm accordingly.
